(19) United States
(12) Patent Application Publication
(10) Pub. No.: US 2025/0377842 A1
(43) Pub. Date: Dec. 11, 2025

(54) IMAGE PROCESSING APPARATUS, METHOD OF CONTROLLING THE SAME, AND STORAGE MEDIUM

(71) Applicant: CANON KABUSHIKI KAISHA, Tokyo (JP)

(72) Inventor: TETSU IMAI, Tokyo (JP)

(21) Appl. No.: 19/220,174

(22) Filed: May 28, 2025

(30) Foreign Application Priority Data
Jun. 5, 2024 (JP) 2024-091659

(51) Int. Cl. G06F 3/12

(52) U.S. Cl. CPC G06F 3/1238; G06F 3/1205; G06F 3/1222; G06F 3/1261

(57) ABSTRACT

An image processing apparatus determines the security level of an obtained job with a job security level determination unit, and determines the security level of the image processing apparatus with a device security level determination unit. The image processing apparatus compares the job security level and the device security level and, in a case where the device security level is lower than the job security level, searches for an image processing apparatus on the same network with a device security level higher than or equal to the job security level, which is able to execute the job, with a network device search unit. In a case where an image processing apparatus which is able to execute the job is present, the image processing apparatus transfers to the job to this image processing apparatus with a job transfer unit without executing the job.

### BACKGROUND

### Field

The present disclosure relates to a technique for controlling an image processing apparatus according to a security level.

### Description of the Related Art

For devices that are connected to and used on networks, the risk of information leakage has become a concern. In office environments, multi-function peripherals are connected to and used on networks. Thus, in some offices, measures are taken such as using separate image processing apparatuses (multi-function peripherals) for confidential jobs and for general jobs. Nonetheless, taking such a measure still entails risks originating from human error by users. For example, a user may accidentally execute a confidential job on a multi-function peripheral that is used for general jobs, which can easily expose themselves to the risk of information leakage.

Japanese Patent Laid-Open No. 2019-016151 discloses a system which, before a personal computer (PC) transmits a job to a multi-function peripheral, causes a censorship server to determine whether the multi-function peripheral has an appropriate security class for executing the job, and prohibits transmission of the job in a case where the security class is determined to be insufficient. The censorship server, which is connected to the PC and the multi-function peripheral, determines the security class based on a device attribute of the multi-function peripheral and job data. The censorship server permits transmission of the job from the PC to the multi-function peripheral only in a case where the censorship server determines that the security class of the multi-function peripheral is higher than the security class of the job data. The PC cannot transmit the job without receiving a transmission permission from the censorship server. This prevents a job from being mistakenly transmitted from the PC to a multi-function peripheral with a security class lower than that of the job and executed by it.

Note that, in a case where the transmission is not permitted, the technique disclosed in Japanese Patent Laid-Open No. 2019-016151 requires the user to find a multi-function peripheral with a security class higher than that of the job and re-transmit the job to that multi-function peripheral, which is troublesome. Moreover, the technique disclosed in Japanese Patent Laid-Open No. 2019-016151, which is designed for transmission of jobs from a PC to a multi-function peripheral, is not applicable to jobs that are generated within multi-function peripherals, such as scanning, copying, and faxing, or multi-function peripherals that are used as stand-alone apparatuses.

In view of this, an object of the present disclosure is to reduce the time and effort required for a user to execute various jobs with appropriate image processing apparatuses according to security levels.

### SUMMARY

The technique of the present disclosure provides an image processing apparatus for controlling execution of a job according to a security level, including: an obtaining unit that obtains a job which uses a function of the image processing apparatus; an identification unit that identifies a job security level of the job obtained by the obtaining unit; a control unit that performs control so as not to complete the job in a case where the security level of the job identified by the identification unit is higher than a security level of the image processing apparatus; and a transfer unit that transfers the job to another image processing apparatus with a security level higher than or equal to the security level of the job in a case where the job is not completed.

Further features of the present disclosure will become apparent from the following description of exemplary embodiments with reference to the attached drawings.

### BRIEF DESCRIPTION OF THE DRAWINGS

FIG. 1 illustrates a system configuration and a network configuration in one embodiment;

FIG. 2 is a hardware configuration diagram of image processing apparatuses in one embodiment;

FIG. 3 is a hardware configuration diagram of a client PC in one embodiment;

FIG. 4 is a functional block diagram of image processing apparatuses in one embodiment;

FIG. 5 is a functional block diagram of a client PC in one embodiment;

FIG. 6 is a flowchart for describing job execution-transfer determination processing performed by an image processing apparatus in Embodiment 1;

FIG. 7 is a flowchart for describing job security level determination processing performed by an image processing apparatus in Embodiment 1;

FIG. 8 is a flowchart for describing device security level determination processing performed by an image processing apparatus in Embodiment 1;

FIG. 9A illustrates a display example of a user interface (UI) screen displayed on an image processing apparatus and a dialogue box displayed on a client PC;

FIG. 9B illustrates a display example of a UI screen displayed on an image processing apparatus and a dialogue box displayed on the client PC;

FIG. 9C illustrates a display example of a UI screen displayed on an image processing apparatus and a dialogue box displayed on the client PC;

FIG. 9D illustrates a display example of a UI screen displayed on an image processing apparatus and a dialogue box displayed on the client PC;

FIG. 9E illustrates a display example of a UI screen displayed on an image processing apparatus and a dialogue box displayed on the client PC;

FIG. 10 illustrates an example of a system configuration and a network configuration in Embodiment 2;

FIG. 11 is a functional block diagram of image processing apparatuses in Embodiment 2;

FIG. 12 is a flowchart for describing job execution-transfer determination processing performed by an image processing apparatus in Embodiment 2;

FIG. 13A illustrates a display example of a UI screen displayed on an image processing apparatus and a dialogue box displayed on a client PC in Embodiment 2;

FIG. 13B illustrates a display example of a UI screen displayed on an image processing apparatus and a dialogue box displayed on the client PC in Embodiment 2;

FIG. 14 is a flowchart for describing job execution-transfer determination processing performed by an image processing apparatus in Embodiment 3; and

FIG. 15 is a flowchart for describing job execution-transfer determination processing performed by an image processing apparatus in Embodiment 4.

### DESCRIPTION OF THE EMBODIMENTS

Embodiments of the technique of the present disclosure will now be described below using the drawings. Information processing systems in these embodiments are applicable to information processing systems including image processing apparatuses and a client PC.

### Embodiment 1

An image processing apparatus according to Embodiment 1 does not execute a job input thereinto in a case where the security level of the job is higher than the security level of the apparatus, and transfers the job to an image processing apparatus with a security level higher than or equal to the security level of the job.

As for the job type, the input job may be a print job transmitted from an external information processing apparatus or a scan job, copy job, fax job, or the like generated by the image processing apparatus.

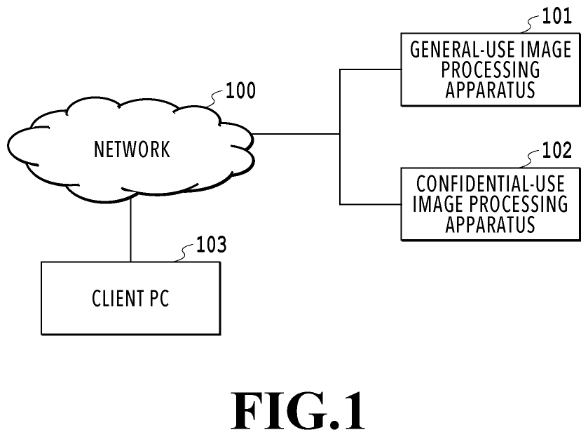

FIG. 1 illustrates a block diagram illustrating an example of a system configuration according to the present embodiment.

A general-use image processing apparatus 101 is an image processing apparatus arranged to be able to execute jobs whose security levels are lower than a predetermined level. A confidential-use image processing apparatus 102 is an image processing apparatus arranged to be able to execute jobs with confidential information whose security levels are higher than or equal to the predetermined level. A client PC 103 is an information processing apparatus capable of transmitting jobs to the general-use image processing apparatus 101 and the confidential-use image processing apparatus 102 through a network 100. Also, the client PC 103 is capable of receiving the results of scan jobs and the like executed by the general-use image processing apparatus 101 and the confidential-use image processing apparatus 102. The general-use image processing apparatus 101, the confidential-use image processing apparatus 102, and the client PC 103 are connected to one another through the network 100.

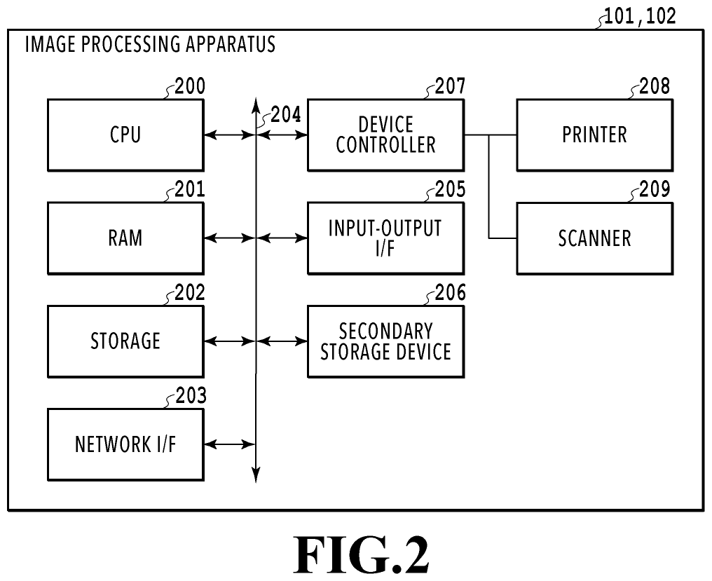

FIG. 2 illustrates a hardware configuration diagram of the general-use image processing apparatus 101 and the confidential-use image processing apparatus 102. A central processing unit (CPU) 200 comprehensively controls the image processing apparatus by executing programs with a random-access memory (RAM) 201 as a work area. A storage 202 stores installed programs and various data. A network interface 203 connects to the network 100 to communicate with external information processing apparatuses, image processing apparatuses, and the like and also network devices in a wired or wireless manner, and may hold a mobile network interface. An input-output interface 205 includes a touch panel, buttons, universal serial bus (USB) connectors, and so on and is capable of receiving and outputting user inputs and data. Incidentally, user inputs and data can be input into and output from an external information processing apparatus via a remote interface or the like instead of the input-output interface 205. A secondary storage device 206 is a secondary storage device as represented by a hard disk drive (HDD), a solid-state drive (SSD), a flash memory, or the like. The CPU 200 is capable of executing programs read out of the RAM 201, the storage 202, the secondary storage device 206, and the like. A device controller 207 controls a printer 208 and a scanner 209 in accordance with control commands output by the CPU 200 based on print jobs, scan jobs, copy jobs, fax jobs, and the like. The printer 208 performs printing on print media to output printed products. The scanner 209 reads printed products to output read images. These components are connected to one another through a system bus 204. Control commends from the CPU 200 can be transferred to the components connected to the system bus 204.

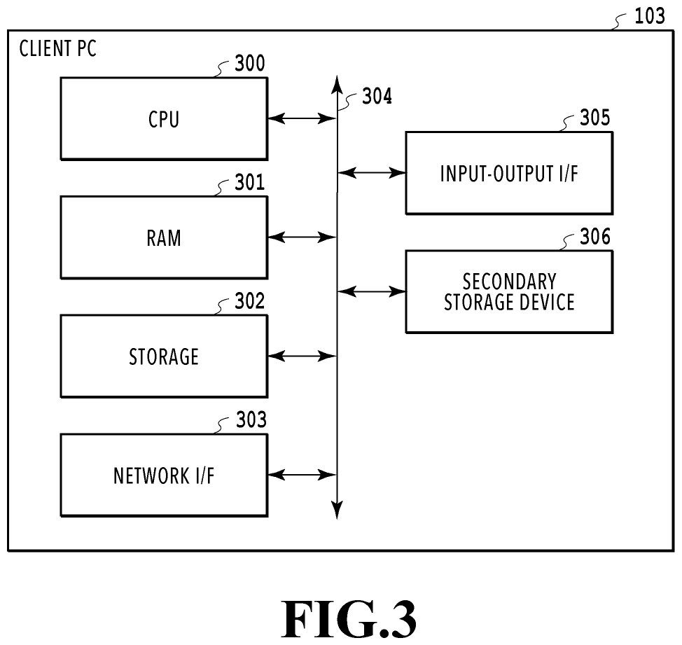

FIG. 3 illustrates a hardware configuration diagram of the client PC 103. A CPU 300 comprehensively controls the client PC 103 by executing programs with a RAM 301 as a work area. A storage 302 stores installed programs and various data. A network interface 303 connects to a network to communicate with external information processing apparatuses and network devices in a wired or wireless manner, and may hold a mobile network interface. An input-output interface 305 is capable of receiving and outputting user inputs and data via a display, a keyboard, a mouse, a touch panel, buttons, and the like. Incidentally, user inputs and data can be input into and output from an external information processing apparatus via a remote desktop, a remote shell, or the like instead of the input-output interface 305. A secondary storage device 306 is a secondary storage device as represented by an HDD, an SSD, a flash memory, or the like. The CPU 300 is capable of executing programs read out of the RAM 301, the storage 302, the secondary storage device 306, and the like. These components are connected to one another through a system bus 304. Control commends from the CPU 300 can be transferred to the components connected to the system bus 304.

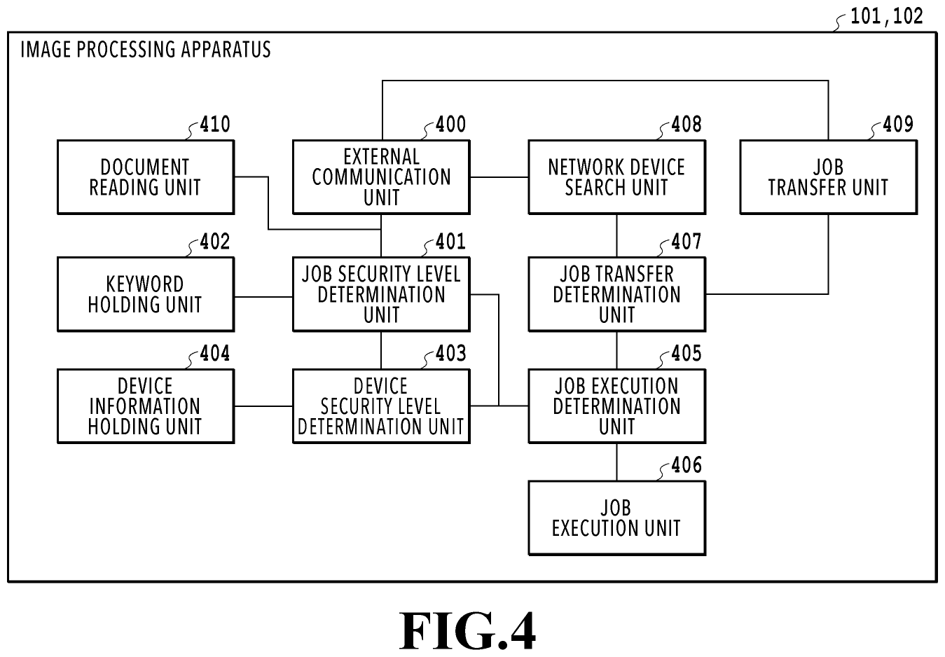

FIG. 4 illustrates a block diagram of example functional arrangements of the general-use image processing apparatus 101 and the confidential-use image processing apparatus 102. The general-use image processing apparatus 101 and the confidential-use image processing apparatus 102 implement each of their programs by reading it out of the RAM 201, the storage 202, the secondary storage device 206, or the like and causing the CPU 200 to execute it. The general-use image processing apparatus 101 and the confidential-use image processing apparatus 102 each access external apparatuses such as other image processing apparatuses and the client PC 103 via the network interface 203. Note that the general-use image processing apparatus 101 and the confidential-use image processing apparatus 102 will be denoted simply as “image processing apparatus” in the description of common functions shared by them.

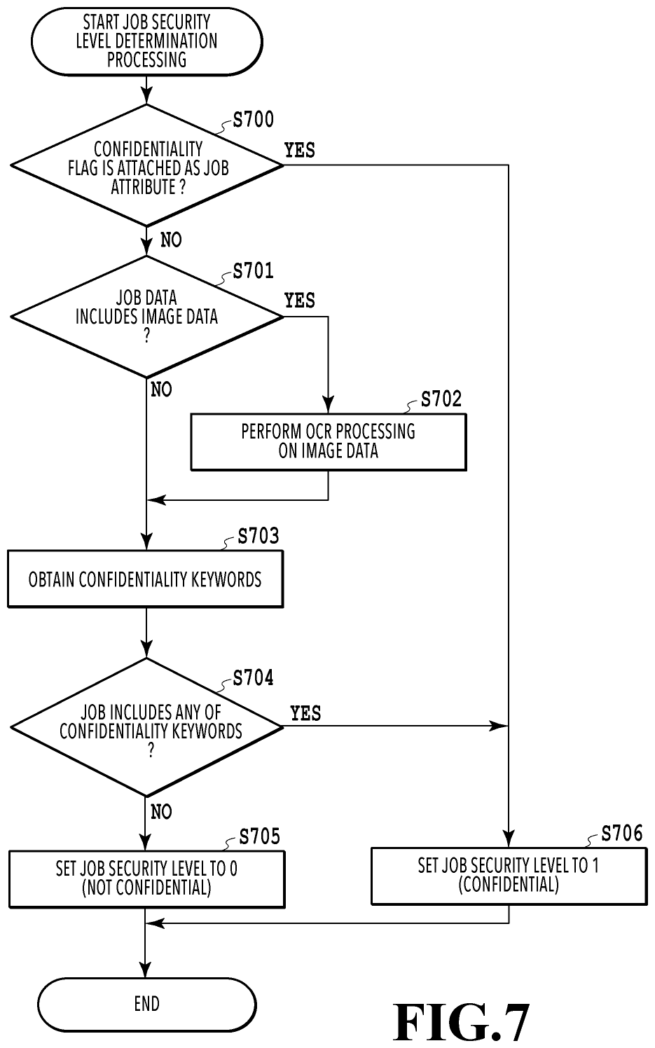

The image processing apparatus print jobs received from the client PC 103 via an external communication unit 400, scan jobs, copy jobs, and fax jobs generated using a document reading unit 410, and the like as jobs to execute. The image processing apparatus determines the security levels of input jobs with a job security level determination unit 401. The job security level determination unit 401 refers to a keyword holding unit 402 in the determination of the job security levels. The keyword holding unit 402 is capable of holding confidentiality keywords registered in advance which serve as criteria for determining whether a job is confidential or not. Examples of the confidentiality keywords held in the keyword holding unit 402 include “For Internal Use Only,” “Confidential,” “Secret,” “Handle with Care,” and the like. Details of the job security level determination processing will be described later using the flowchart illustrated in FIG. 7.

The image processing apparatus determines its security level with a device security level determination unit 403. The device security level determination unit 403 refers to device information held in a device information holding unit 404 in the determination of the device security level. The device information holding unit 404 is capable of holding device information as below as information on the image processing apparatus' device name, installation location, and various settings. In the following example, the device security level is not explicitly included. The device security level determination unit 403 therefore determines the device security level based on attribute values related to a registry cache setting, an external server automatic upload setting, and a forced copy-forgery-inhibited pattern printing setting.

### Example of Device Information of Image Processing Apparatus

```
{
  “DeviceName”:“DEVICE001”,
  “ProductName”:“iDevice-Color1000”,
    “Location”:“2F entrance”,
    “RegistryCache”:“ON”,
    “ServerAutoUpload”:“OFF”,
    “ForceBackgrounfPrint”:“OFF”
}
```

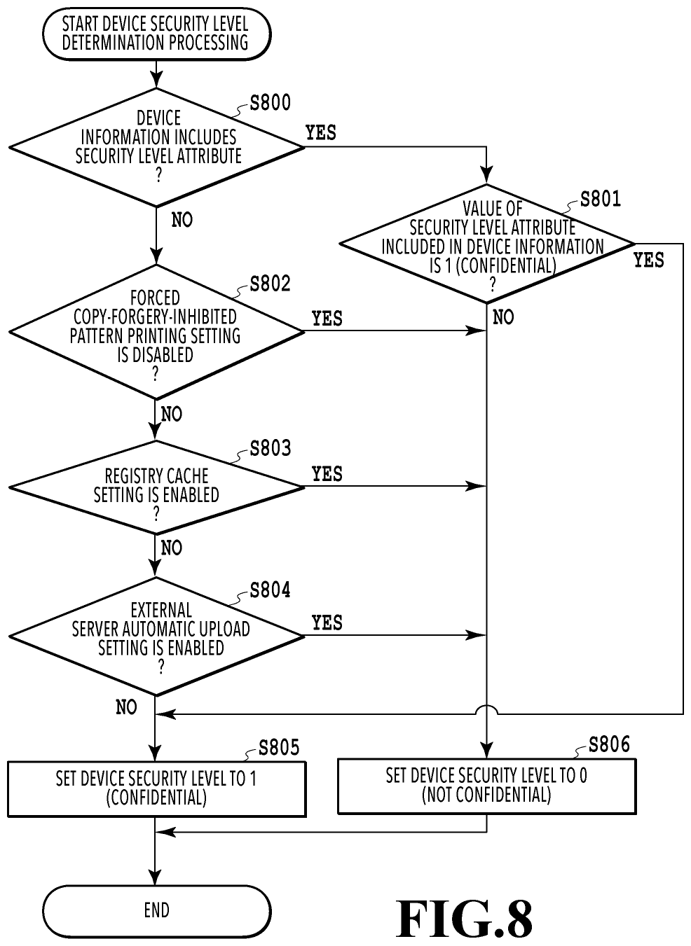

Details of the device security level determination processing will be described later using the flowchart illustrated in FIG. 8.

A job execution determination unit 405 compares a job security level and the device security level, and determines that the job can be executed in a case where the device security level is higher than or equal to the job security level. In the case where the job execution determination unit 405 determines that the job can be executed, the image processing apparatus causes a job execution unit 406 to execute the job.

On the other hand, in a case where the device security level is lower than the job security level, the job execution determination unit 405 determines that the job cannot be executed. In the case where the job execution determination unit 405 determines that the job cannot be executed, the image processing apparatus performs a job transfer determination with a job transfer determination unit 407.

The job transfer determination unit 407 transmits a network device search message via a network device search unit 408 to detect image processing apparatuses on the same network that can communicate. Each image processing apparatus having received the network device search message transmits device information including its device security level with its device security level determination unit 403 as a response to the received network device search message.

The image processing apparatus having transmitted the network device search message receives the response to the network device search message with the network device search unit 408. The job transfer determination unit 407 determines whether an image processing apparatus with a device security level higher than or equal to the job security level is present among the image processing apparatuses having transmitted the responses received by the network device search unit 408. In a case where an image processing apparatus with a device security level higher than or equal to the job security level is present, the job transfer unit 409 transfers the job to that image processing apparatus. In a case where no image processing apparatus with a device security level higher than or equal to the job security level is present, the image processing apparatus aborts the execution of the job by itself or another image processing apparatus.

In a case of transferring a job input from the client PC 103, the image processing apparatus may transmit a transfer message indicating that the job has been transferred to the client PC 103. An example of the transfer message is written below.

### Example of Transfer Message

```
{
  “JobId”:“JOB0001”,
  “Document”:“secure.txt”,
  “Status”:“Transfered”,
    “TransferFrom”:{
    “DeviceName”:“Device001”,
      “Location”:“2F entrance”
},
    “TransferTo”:{
    “DeviceName”:“Device002”,
      “Location”:“2F secret room”
}
}
```

In a case of aborting the execution of a job input from the client PC 103, the image processing apparatus may likewise transmit an abortion message indicating that the execution of the job has been aborted to the client PC 103. An example of the abortion message is written below.

### Example of Abortion Message

```
{
  “JobId”:“JOB0002”,
  “Document”:“secure.txt”,
  “Status”:“Stopped”,
    “DeviceName”:“Device001”,
    “Location”:“2F entrance”
}
```

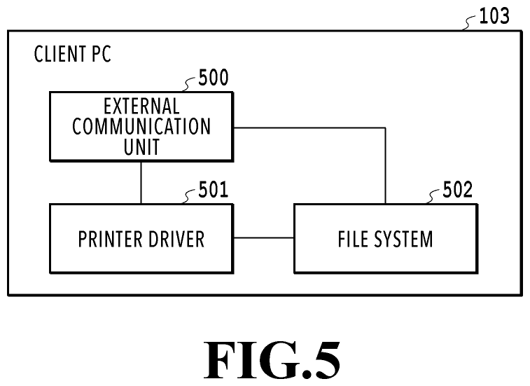

FIG. 5 illustrates a block diagram of an example functional arrangement of the client PC 103. The client PC 103 implements each of its programs by reading it out of the RAM 301, the storage 302, the secondary storage device 306, or the like and causing the CPU 300 to execute it. The client PC 103 communicates with external apparatuses on a network, such as the general-use image processing apparatus 101 and the confidential-use image processing apparatus 102, via the network interface 303.

The client PC 103 has a printer driver 501 and a file system 502. The client PC 103 is capable of generating print jobs with the printer driver 501 from files held in the file system 502. The client PC 103 is capable of transmitting the generated print jobs to the general-use image processing apparatus 101 or the confidential-use image processing apparatus 102 via an external communication unit 500. The client PC 103 is also capable of receiving scan image data obtained by the general-use image processing apparatus 101 or the confidential-use image processing apparatus 102 by reading a document, and holding the scan image data in the file system 502.

The client PC 103 may cause the printer driver 501 to display a transfer dialogue on a UI in response to receiving a transfer message as a response to a print job transmitted to an image processing apparatus. The client PC 103 may cause the printer driver 501 to display an abortion dialogue on a UI in response to receiving an abortion message as a response to a print job transmitted to an image processing apparatus.

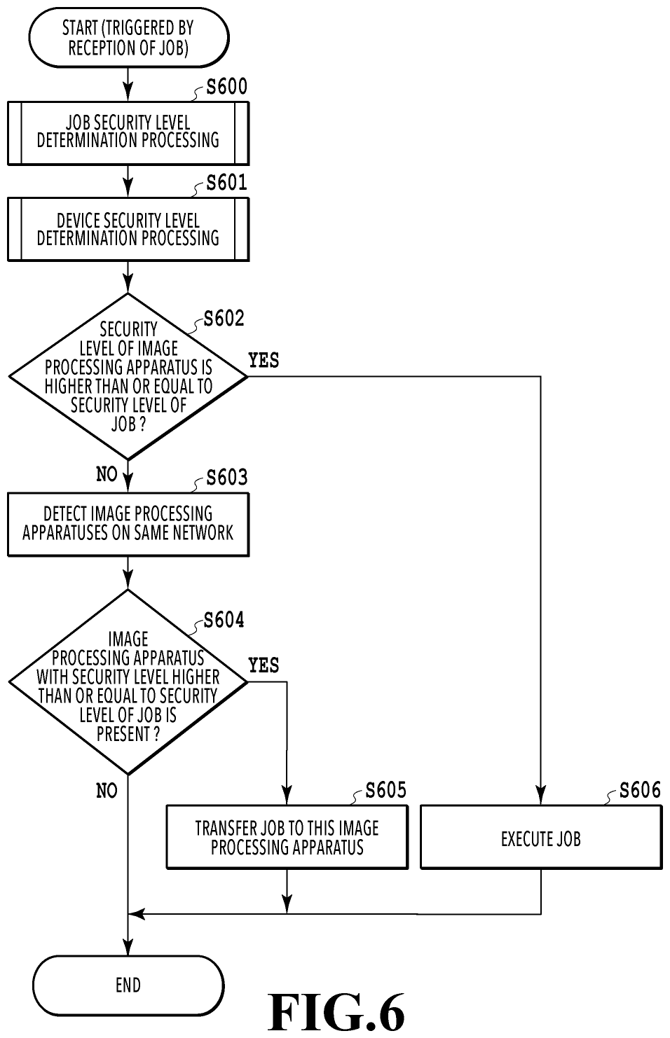

FIG. 6 is a flowchart for describing job execution-transfer determination processing performed by the image processing apparatus according to Embodiment 1. The image processing apparatus (101, 102) starts this flowchart in response to obtaining of a job to be executed as a trigger.

In S600, the job security level determination unit 401 determines the security level of the obtained job. Details of the job security level determination processing will be described later using the flowchart illustrated in FIG. 7.

In S601, the device security level determination unit 403 determines the security level of the local image processing apparatus. Details of the device security level determination processing will be described later using the flowchart illustrated in FIG. 8.

In S602, the job execution determination unit 405 compares the job security level and the device security level with each other. The job execution determination unit 405 proceeds to S606 if the device security level is higher than or equal to the job security level, and proceeds to S603 if the device security level is lower than the job security level.

In S603, the job transfer determination unit 407 transmits a network device search message via the network device search unit 408 to detect image processing apparatuses on the same network that can communicate.

In S604, the job transfer determination unit 407 receives via the network device search unit 408 responses to the network device search message from image processing apparatuses on the same network that can communicate. Based on the received responses to the network device search message, the job transfer determination unit 407 determines whether an image processing apparatus with a device security level higher than or equal to the job security level is present. The job transfer determination unit 407 proceeds to S605 if an image processing apparatus with a device security level higher than or equal to the job security level, which is able to execute the job, is present, and aborts the job and terminates the processing if no image processing apparatus which is able to execute the job is present.

In S605, the job transfer unit 409 transfers the job to the image processing apparatus with a device security level higher than or equal to the job security level, aborts the job, and terminates the processing.

In S606, the job execution unit 406 executes the obtained job and terminates the processing.

Note that the abortion of the job in S604 and S605 means not to execute any part of the job in a case where it is a print job, and, in a case where it is a job involving reading of a document, such as a scan job, means to read the document but omit the subsequent transmission or printing of data.

FIG. 7 illustrates a flowchart for describing the job security level determination processing in S600 illustrated in FIG. 6.

In S700, the job security level determination unit 401 confirms whether a security level attribute, e.g., a confidentiality flag, is attached as an attribute included in the job. The printer driver 501 attaches this confidentiality flag when the job is transmitted from the client PC 103, for example. The job security level determination unit 401 proceeds to S706 if the confidentiality flag is attached to the job, and proceeds to S701 if the confidentiality flag is not attached to the job.

In S701, the job security level determination unit 401 determines whether the obtained job includes image data. The job security level determination unit 401 proceeds to S702 if the obtained job includes image data, and proceeds to S703 if the obtained job includes no image data. Note that, in a case where the job is a job that involves obtaining read image data, such as a scan job, operations up to the obtaining of read image data are performed and, if read image data is successfully obtained, the job security level determination unit 401 determines that the job includes image data.

In S702, the job security level determination unit 401 performs optical character recognition (OCR) processing on the image data included in the job to obtain character information (character codes) corresponding to the character image included in the image data.

In S703, the job security level determination unit 401 obtains confidentiality keywords which serve as criterion for determining whether the job is confidential from the keyword holding unit 402.

In S704, the job security level determination unit 401 determines whether the character information included in the job includes any of the obtained confidentiality keywords. Note that the character information included in the job mentioned above includes character information originally included in the job as character information, and character information obtained from the image data included in the job. The job security level determination unit 401 proceeds to S706 if the character information included in the job includes any of the confidentiality keywords, and proceeds to S705 if the character information includes none of the confidentiality keywords.

In S705, the job security level determination unit 401 identifies 0 (not confidential) as the job security level, and terminates the processing.

In S706, the job security level determination unit 401 identifies 1 (confidential) as the job security level, and terminates the processing.

Note that, in the present embodiment, the job security level is one of two levels represented by two values of 1 (confidential) and 0 (not confidential), but a job security level represented by three or more values corresponding to the number of confidentiality keywords included may be used, for example.

FIG. 8 illustrates a flowchart for describing the device security level determination processing in S601 illustrated in FIG. 6.

In S800, the device security level determination unit 403 obtains device information from the device information holding unit 404. The device security level determination unit 403 proceeds to S801 if it obtains device information including the device security level, and proceeds to S802 if failing to obtain that device information.

From S801, the device security level determination unit 403 proceeds to S805 if the value of a security level attribute included in the device information is 1 (confidential), and proceeds to S806 if the value of the security level attribute is 0 (not confidential).

In S802, the device security level determination unit 403 determines whether the forced copy-forgery-inhibited pattern printing setting is disabled. The device security level determination unit 403 proceeds to S806 if the forced copy-forgery-inhibited pattern printing setting is disabled, and proceeds to S803 if the forced copy-forgery-inhibited pattern printing setting is enabled.

In S803, the device security level determination unit 403 determines whether the registry cache setting, which is a setting for holding image data included in executed job data, read image data obtained by executing jobs, and the like in the image processing apparatus, is enabled. The device security level determination unit 403 proceeds to S806 if the registry cache setting is enabled, and proceeds to S804 if the registry cache setting is disabled.

In S804, the device security level determination unit 403 determines whether the external server automatic upload setting, which is a setting for automatically uploading image data included in executed job data, image data obtained by executing jobs, and the like to an external server, is enabled. The device security level determination unit 403 proceeds to S806 if the external server automatic upload setting is enabled, and proceeds to S805 if the external server automatic upload setting is disabled.

In S805, the device security level determination unit 403 identifies 1 (confidential) as the device security level, and terminates the processing.

In S806, the device security level determination unit 403 identifies 0 (not confidential) as the device security level, and terminates the processing.

In the present embodiment, as described above, in a case where the device information includes no security level attribute, the device security level is determined based on the three attribute values, namely the forced copy-forgery-inhibited pattern printing setting, the registry cache setting, and the external server automatic upload setting. In the present embodiment, the device security level is determined to be 0 (not confidential) in a case where the forced copy-forgery-inhibited pattern printing setting is disabled, the registry cache setting is enabled, or the external server automatic upload setting is enabled. The device security level is determined to be 1 (confidential) in a case where the forced copy-forgery-inhibited pattern printing setting is enabled, the registry cache setting is disabled, and the external server automatic upload setting is disabled. Note that the attribute values used to determine the device security level are not limited to the three attribute values described above, and a configuration that uses other attribute values or the like may be employed.

Also, in the present embodiment, the device security level is a level represented by one of binary values of 1 (confidential) and 0 (not confidential), but a device security level represented by three or more values corresponding to the number of attribute values satisfying given conditions may be used, for example.

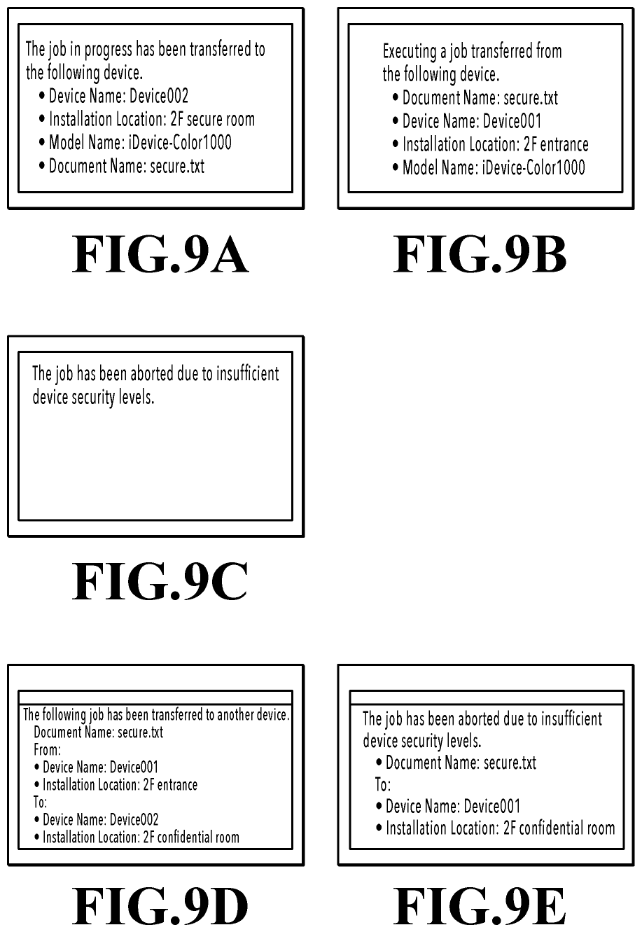

FIGS. 9A to 9E illustrate an example of UI screens on the general-use image processing apparatus 101, the confidential-use image processing apparatus 102, and the client PC 103 according to the present embodiment. FIG. 9A is an example of a UI screen that is controlled to be displayed by the job transfer determination unit 407 of the general-use image processing apparatus 101 in a case where the image processing apparatus transfers a confidential job (S605). FIG. 9B is an example of a UI screen that is controlled to be displayed by the job execution determination unit 405 of the confidential-use image processing apparatus 102 in a case where the image processing apparatus obtains a confidential job. FIG. 9C is an example of a UI screen that is controlled to be displayed by the job transfer determination unit 407 of the general-use image processing apparatus 101 in a case where the image processing apparatus fails to find an image processing apparatus to which to transfer a confidential job (S604).

FIG. 9D is an example of a transfer dialogue that is displayed on the client PC 103. The job transfer determination unit 407 of the general-use image processing apparatus 101 transmits a transfer message to the client PC 103 when the image processing apparatus transfers a confidential job transmitted from the client PC 103 (S605). The transfer dialogue is an example of a dialogue box that is controlled to be displayed by the printer driver 501 in a case where the client PC 103 receives the job transfer message as a response.

FIG. 9E is an example of an abortion dialogue that is displayed on the client PC 103. In a case where the general-use image processing apparatus 101 fails to find an image processing apparatus to which to transfer a confidential job transmitted from the client PC 103 (S604), the job transfer determination unit 407 transmits a message indicating that the execution of the job has been aborted to the client PC 103. The abortion dialogue is an example of a dialogue box that is controlled to be displayed by the printer driver 501 in a case where the client PC 103 receives the job execution abortion message as a response.

### Embodiment 2

Embodiment 2 will now be described below focusing on its difference from Embodiment 1.

In a highly secure office environment, the confidential-use image processing apparatus 102 may sometimes operate as a stand-alone apparatus without being connected to the network 100. Applying Embodiment 1 to this case can prevent execution of confidential jobs by the general-use image processing apparatus 101 but cannot transfer confidential jobs input into the general-use image processing apparatus 101 to the confidential-use image processing apparatus 102 and cause the confidential-use image processing apparatus 102 to execute the jobs.

To address this, in Embodiment 2, the general-use image processing apparatus 101 holds information on the confidential-use image processing apparatus 102 in advance, and displays the information on the confidential-use image processing apparatus 102 on the input-output interface 305 in a case where a confidential job is input into the general-use image processing apparatus 101. Embodiment 2 can present device information of an image processing apparatus that is able to execute a confidential job input into the general-use image processing apparatus 101, such as its device name and installation location, instead of transferring the confidential job to the confidential-use image processing apparatus 102. This allows the user to easily find an image processing apparatus that is able to execute the confidential job. Embodiment 2 will now be described below focusing on its difference from Embodiment 1.

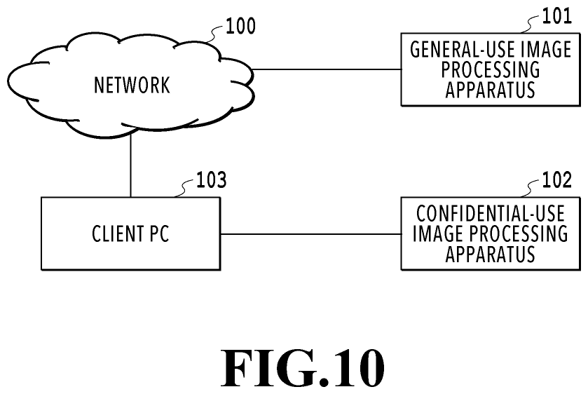

FIG. 10 illustrates an example of the system configuration and the network configuration in Embodiment 2. The general-use image processing apparatus 101 and the client PC 103 are connected to each other through the network 100. The confidential-use image processing apparatus 102, on the other hand, is not connected to the network 100, and is directly connected to the client PC 103 by a physical cable or the like such that the confidential-use image processing apparatus 102 can be used by the client PC 103. Note that the hardware configurations of the general-use image processing apparatus 101 and the confidential-use image processing apparatus 102 are the same as those in Embodiment 1 (FIG. 2), and description thereof is therefore omitted.

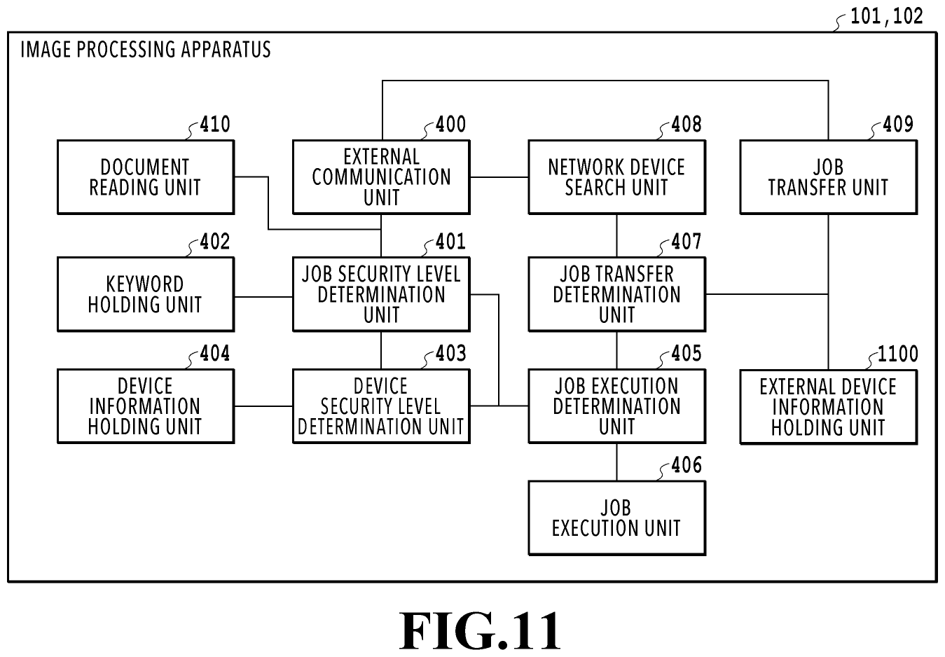

FIG. 11 illustrates a block diagram of example functional arrangements of the general-use image processing apparatus 101 and the confidential-use image processing apparatus 102 in Embodiment 2. Each of the image processing apparatuses according to the present embodiment further includes an external device information holding unit 1100 in addition to the components according to Embodiment 1. Each of the image processing apparatuses implement each of its programs by reading it out of the RAM 201, the storage 202, the secondary storage device 206, or the like and causing the CPU 200 to execute it, as in Embodiment 1. The image processing apparatus accesses external apparatuses, such as other image processing apparatus and the client PC, via the network interface 203.

The external device information holding unit 1100 holds device information on external image processing apparatuses, such as the device names, installation locations, model names, and device security levels of image processing apparatuses other than the local image processing apparatus. In a case where an image processing apparatus with a device security level higher than or equal to a job security level cannot be found on the network 100, the job transfer determination unit 407 obtains the device information from the external device information holding unit 1100. From the obtained device information, the job transfer determination unit 407 extracts a piece of device information on an external image processing apparatus with a device security level higher than or equal to the job security level. The job transfer determination unit 407 displays the extracted piece of device information in the form of a recommended device indication message on a UI of the local image processing apparatus or of the client PC 103. An example of the recommended device indication message is written below.

### Example of Recommended Device Indication Message

```
{
  “JobId”:“JOB0003”,
  “Document”:“secure.txt”,
  “Status”:“Stopped”,
    “Recommendation”:{
    “DeviceName”:“Device002”,
      “Location”:“2F secret room”
}
}
```

On the other hand, in a case of failing to extract a piece of device information of an external image processing apparatus with a device security level higher than or equal to the job security level from the device information, the job transfer determination unit 407 simply terminates the processing. Incidentally, a job execution abortion message as illustrated in FIG. 9C may be displayed at this time on the display device of the local image processing apparatus or of the client PC 103.

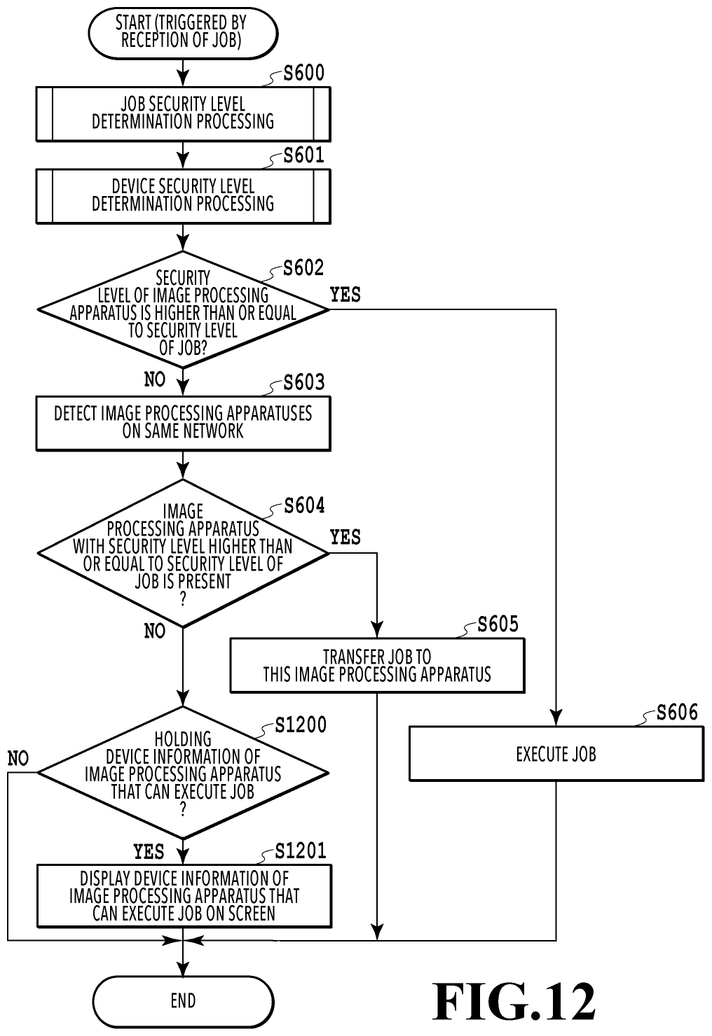

FIG. 12 is a flowchart for describing job execution-transfer determination processing performed by an image processing apparatus in Embodiment 2. An image processing apparatus (101, 102) starts this flowchart in response to obtaining of a job to be executed as a trigger. S600 to S606 are the same as those in Embodiment 1, and description thereof is therefore omitted. Note that the image processing apparatus proceeds to S1200 if determining in S604 that no image processing apparatus with a device security level higher than or equal to the job security level is present.

In S1200, the image processing apparatus determines whether the external device information holding unit 1100 is holding a piece of device information of an image processing apparatus with a device security level higher than or equal to the job security level. The image processing apparatus proceeds to S1201 if the external device information holding unit 1100 is holding a piece of device information of an image processing apparatus with a device security level higher than or equal to the job security level, and terminates the processing without executing the job if the external device information holding unit 1100 is not holding such a piece of device information.

In S1201, the image processing apparatus displays the information of the image processing apparatus with a device security level higher than or equal to the job security level on a UI of the image processing apparatus or of the client PC 103, and terminates the processing without executing the job.

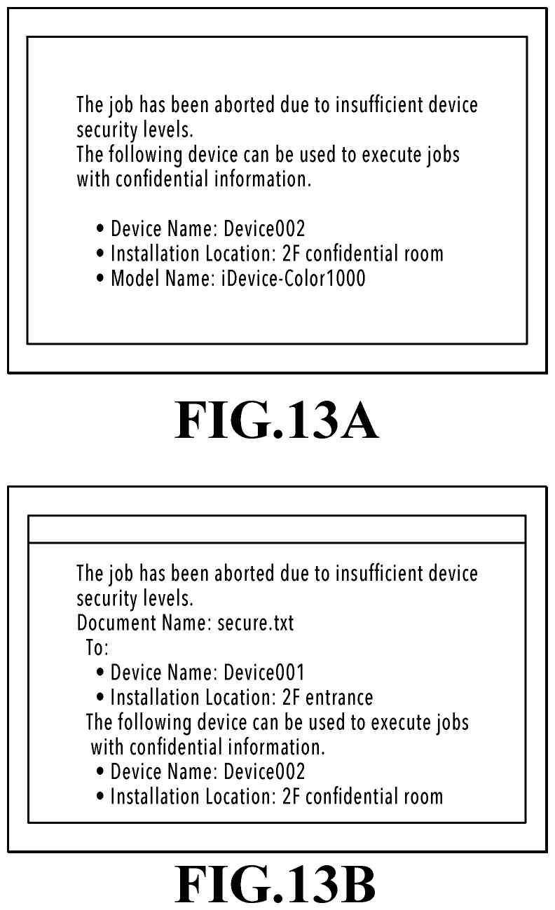

FIGS. 13A and 13B illustrate an example of recommended device indication messages that are displayed on the image processing apparatus and the client PC 103 in Embodiment 2. FIG. 13A is displayed on the general-use image processing apparatus 101 in a case where the image processing apparatus fails to find an image processing apparatus on the network 100 to which to transfer the job and the external device information holding unit 1100 is holding the device information of the confidential-use image processing apparatus 102. FIG. 13B is displayed on the client PC 103 in a case where the general-use image processing apparatus 101 fails to find the confidential-use image processing apparatus 102 on the network 100 and the external device information holding unit 1100 is holding the device information of the confidential-use image processing apparatus 102. In a case of receiving a recommended device indication message from the general-use image processing apparatus 101 as a response to a job transmitted thereto, the client PC 103 displays the recommended device indication message received by the printer driver 501 in a dialogue box.

Note that the device information held in the external device information holding unit 1100 may only include the device information of the confidential-use image processing apparatus 102 as the device information of an external image processing apparatus. In that case, the device information does not need to include the device security level.

### Embodiment 3

Embodiment 3 will now be described below focusing on its difference from Embodiment 1.

In office environments that established in large premises or high-rise buildings, many image processing apparatuses with different security levels may exist. In this case, transferring a job to an image processing apparatus located far for its high security level could significantly lower convenience. To address this, in Embodiment 3, in a case where an image processing apparatus transfers a job, it performs control so as to transfer the job to an image processing apparatus installed at a closer location to itself.

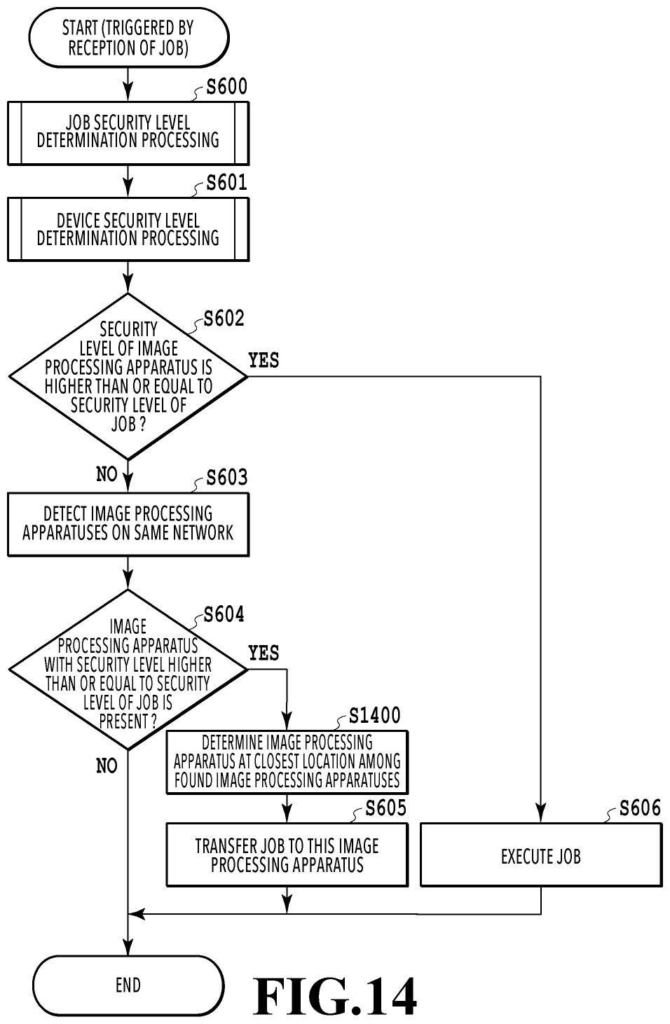

FIG. 14 illustrates a flowchart for describing job execution-transfer determination processing performed by an image processing apparatus before execution of a job according to the present embodiment.

FIG. 14 is a flowchart of job execution-transfer determination processing executed by an image processing apparatus (101, 102) in Embodiment 3.

In S1400, in a case where multiple image processing apparatuses with device security levels higher than or equal to a job security level are present, the job transfer determination unit 407 determines the image processing apparatus at the closest location among them. A specific procedure for determining the image processing apparatus at the closest location involves checking area information of image processing apparatuses included in their responses to the network device search message, and comparing the area information with the information of the local image processing apparatus. An example of setting information of the transfer source image processing apparatus (local image processing apparatus) is written below.

### Example of Setting Information of Transfer Source Image Processing Apparatus

```
{
  “DeviceName”:“DEVICE001”,
  “ProductName”:“iDevice-Color1000”,
    “Location”:“2F entrance”,
    “AreaInfo”:“A building”,
    “FloorInfo”:“2”,
}
```

An example of the responses to the network device search message is written below.

### Example of Responses to Network Device Search Message

```
[{
  “DeviceName”:“DEVICE002”,
    “IPAddress”:“XXX.XXX.XXX.XXX”,
    “SecurityLevel”:“1”,
    “Location”:“2F room 201”,
    “AreaInfo”:“B building”,
    “FloorInfo”:“2”,
},{
  “DeviceName”:“DEVICE003”,
    “IPAddress”:“YYY.YYY.YYY.YYY”,
    “SecurityLevel”:“1”,
    “Location”:“1401”,
    “AreaInfo”:“A building”,
    “FloorInfo”:“14”,
},{
  “DeviceName”:“DEVICE004”,
    “IPAddress”:“ZZZ.ZZZ.ZZZ.ZZZ”,
    “SecurityLevel”:“1”,
    “Location”:“3F secret room”,
    “AreaInfo”:“A building”,
    “FloorInfo”:“3”,
}]
```

In the above example, the job transfer determination unit 407 checks the area information (“AreaInfo”) first. The image processing apparatuses having the same area information as that of the transfer source image processing apparatus (local image processing apparatus) are DEVICE003 and DEVICE004. Next, the job transfer determination unit 407 checks floor information (“FloorInfo”) of DEVICE003 and DEVICE004. The image processing apparatus that has close floor information to that of the transfer source image processing apparatus is DEVICE004. In this case, the job transfer determination unit 407 identifies DEVICE004 as the image processing apparatus determined to be at the closest location, and the job transfer unit 409 transfers the job to the image processing apparatus DEVICE004 determined to be at the closest location.

### Embodiment 4

Embodiment 4 will now be described below focusing on its difference from Embodiment 1.

In Embodiment 1, each image processing apparatus aborts execution of an obtained job in a case where its security level is lower than the security level of the job and a destination to which to transfer the job cannot be found. Here, it is desirable to avoid abortion of job execution as much as possible. In view of this, in Embodiment 4, in a case where the general-use image processing apparatus 101 obtains a confidential job but fails to transfer the job to the confidential-use image processing apparatus 102, the general-use image processing apparatus 101 temporarily changes its setting to raise its security level and thereby make itself able to execute the confidential job. In the present embodiment, the general-use image processing apparatus 101 temporarily enables the forced copy-forgery-inhibited pattern printing setting to raise its device security level and thereby make itself able to execute the confidential job.

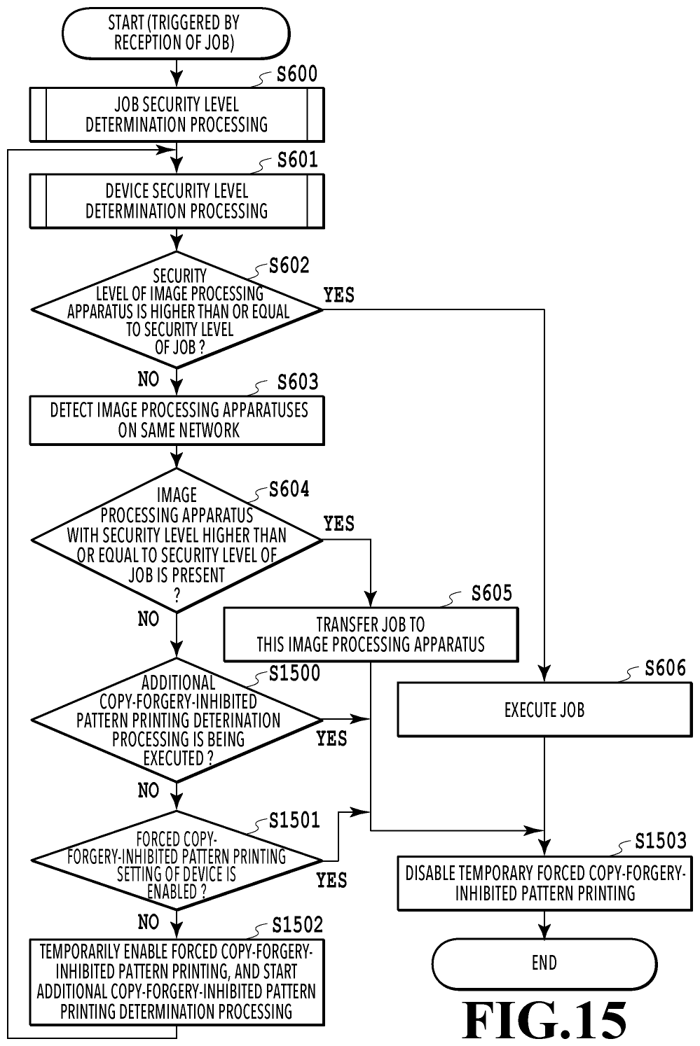

FIG. 15 illustrates a flowchart for describing job execution-transfer determination processing performed by an image processing apparatus before execution of a job.

FIG. 15 is a flowchart of job execution-transfer determination processing executed by the general-use image processing apparatus 101 or the confidential-use image processing apparatus 102 in Embodiment 4. An image processing apparatus (101, 102) starts this flowchart in response to obtaining of a job to be executed as a trigger. S600 to S606 are the same as those in Embodiment 1, and description thereof is therefore omitted. Note that the image processing apparatus proceeds to S1500 if determining in S604 that no image processing apparatus with a device security level higher than or equal to the job security level is present. Also, the image processing apparatus does not terminate the processing after S605 and S606, and proceeds to S1503.

In S1500, the job execution determination unit 405 determines via the device information holding unit 404 whether additional copy-forgery-inhibited pattern printing determination processing, which is started in S1502 to be described later, is being executed. In a case where a temporary forced copy-forgery-inhibited pattern printing setting is enabled, the job execution determination unit 405 determines that the additional copy-forgery-inhibited pattern printing determination processing is being executed, and proceeds to S1503. In a case where the temporary forced copy-forgery-inhibited pattern printing setting is disabled, the job execution determination unit 405 determines that the additional copy-forgery-inhibited pattern printing determination processing is not being executed, and proceeds to S1501.

In S1501, in the case where the additional copy-forgery-inhibited pattern printing determination processing is not being executed, the job execution determination unit 405 confirms whether the forced copy-forgery-inhibited pattern printing setting is enabled.

In S1502, in the case where the forced copy-forgery-inhibited pattern printing setting is disabled, the job execution determination unit 405 enables the temporary forced copy-forgery-inhibited pattern printing setting and starts the additional copy-forgery-inhibited pattern printing determination processing. The additional copy-forgery-inhibited pattern printing determination processing is processing that is re-executed from the processing for determining the security level of the image processing apparatus (S601) with the temporary forced copy-forgery-inhibited pattern printing setting enabled.

In S1503, the job execution determination unit 405 sets the temporary forced copy-forgery-inhibited pattern printing setting back to the disabled state, and terminates the processing without executing the job.

Note that the present embodiment makes a setting change to raise the device security level by temporarily enabling the forced copy-forgery-inhibited pattern printing setting, but the setting change for raising the device security level is not limited to this. For example, the setting change for raising the device security level may include temporarily disabling the registry cache setting and/or the external server automatic upload setting in addition to temporarily enabling the forced copy-forgery-inhibited pattern printing setting.

Note that the configurations described in Embodiments 1 to 4 do not necessarily need to include the same number of apparatuses as those in the entire configurations illustrated in FIGS. 1 and 10. Specifically, three or more image processing apparatuses and/or two or more client PCs may be connected.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the technique of the present disclosure, it is possible to reduce the time and effort required for a user to execute various jobs with appropriate image processing apparatuses.

This application claims the benefit of Japanese Patent Application No. 2024-091659 filed Jun. 5, 2024, which is hereby incorporated by reference wherein in its entirety.

1. An image processing apparatus for controlling execution of a job according to a security level, comprising:
an obtaining unit that obtains a job which uses a function of the image processing apparatus;
an identification unit that identifies a job security level of the job obtained by the obtaining unit;
a control unit that performs control so as to abort the job in a case where the security level of the job identified by the identification unit is higher than a security level of the image processing apparatus;
a transfer unit that transfers the job to another image processing apparatus with a security level higher than or equal to the security level of the job in a case where the job is aborted; and
a display control unit that displays information on the other image processing apparatus with the security level higher than or equal to the security level of the job on a user interface in a case where the control unit performs control so as to abort the job and the transfer unit is unable to transfer to the job.

2. The image processing apparatus according to claim 1, wherein the identification unit identifies the security level of the image processing apparatus based on a setting of a predetermined function of the image processing apparatus.

3. The image processing apparatus according to claim 1, wherein the identification unit identifies the security level of the job based on a value of a security level attribute included in the job.

4. The image processing apparatus according to claim 1, wherein in a case where the job is a print job, the identification unit identifies the security level of the job based on character information extracted from image data included in the job.

5. The image processing apparatus according to claim 1, wherein in a case where the job is a job that involves reading a document with a scanner, the identification unit identifies the security level of the job based on character information extracted from read image data obtained by reading the document.

6. The image processing apparatus according to claim 4, wherein character information corresponding to the security level of the job is held in the identification unit in advance.

7. The image processing apparatus according to claim 1, wherein the transfer unit
includes a search unit that searches for other image processing apparatuses which are able to perform communication with the image processing apparatus and that obtains device information of the other image processing apparatuses, and
transfers the job to the other image processing apparatus with a security level higher than or equal to the security level of the job based on the device information obtained by the search unit.

8. The image processing apparatus according to claim 1, wherein the transfer unit
includes a storage unit storing device information of the other image processing apparatus, and
transfers the job to the other image processing apparatus with a security level higher than or equal to the security level of the job detected based on the device information.

9. The image processing apparatus according to claim 7, wherein
the device information includes information on installation locations of the other image processing apparatuses, and
in a case where a plurality of the other image processing apparatuses with security levels higher than or equal to the security level of the job are present, the transfer unit transfers the job to the other image processing apparatus installed at a closest location to the image processing apparatus.

10. The image processing apparatus according to claim 1, further comprising a setting change unit that makes a setting change for raising the security level of the image processing apparatus in a case where the security level of the job is higher than the security level of the image processing apparatus.

11. The image processing apparatus according to claim 1, wherein
the security level of the image processing apparatus indicates whether the image processing apparatus is for execution of confidential jobs, and
the security level of the job indicates whether the job is confidential.

12. A method of controlling an image processing apparatus for controlling execution of a job according to a security level, the method comprising:
obtaining a job which uses a function of the image processing apparatus;
identifying a job security level of the job obtained in the obtaining;
performing control so as to abort the job in a case where the security level of the job identified in the identifying is higher than a security level of the image processing apparatus; and
transferring the job to another image processing apparatus with a security level higher than or equal to the security level of the job in a case where the job is aborted.

13. A non-transitory computer readable storage medium storing a program which causes a computer to execute a method of controlling an image processing apparatus for controlling execution of a job according to a security level, the method comprising:
obtaining a job which uses a function of the image processing apparatus;
identifying a job security level of the job obtained in the obtaining;
performing control so as to abort the job in a case where the security level of the job identified in the identifying is higher than a security level of the image processing apparatus; and
transferring the job to another image processing apparatus with a security level higher than or equal to the security level of the job in a case where the job is aborted.
